(19) United States
(12) Patent Application Publication
(10) Pub. No.: US 2007/0061801 A1
(43) Pub. Date: Mar. 15, 2007

(54) FILE SYSTEM BUILDER AND METHOD FOR BUILDING FILE SYSTEM

(76) Inventors: Ching-Chih Chang, Taipei Hsien (TW); Yung-Chih Lin, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/164,062

(22) Filed: Nov. 9, 2005

(30) Foreign Application Priority Data
Sep. 9, 2005 (TW) 94131046

(51) Int. Cl. G06F 9/445

(52) U.S. Cl. 717/174

(57) ABSTRACT

The invention is directed to a file system builder for building a file system from a source package database of a source machine with a first platform according to a keyword, wherein the file system can be installed into a target machine with a second platform. The system builder comprises a file system, a generator and a fine tuner. The file system builder engine is used for performing a first query-response communication with the source machine according to the keyword to obtain a package list from the source package database and building up a package table according to the package list, wherein the package list comprises at least one package name. The generator is used for generating a target package set according to the package table and the second platform. The fine tuner is used for adjusting the target package set to be a file system.

### CROSS-REFERENCE TO RELATED APPLICATION

This application claims the priority benefit of Taiwan application serial no. 94131046, filed on Sep. 9, 2005. All disclosure of the Taiwan application is incorporated herein by reference.

### BACKGROUND OF THE INVENTION

1. Field of Invention

The present invention relates to a file system builder and a method for building up a file system. More particularly, the present invention relates to a file system builder for multi platforms and an operating method for the same.

2. Description of Related Art

Currently, the sale volume of the semiconductor chips applied to the consumer electronic product is getting beyond that applied to the enterprise application product. This tendency shows that the consumer electronic product becomes the driving force to advance the total profits of the semiconductor industry. Meanwhile, because of the variety of the appearance and multi function of the digital consumer products such as digital camera, MP3 player, digital video disc player (DVD player), the digital consumer products become the most popular product. Therefore, the development of the digital consumer products becomes the lead of the consumer electronic product research.

However, under the consumers' rapid consuming behaviors, the digital consumer products should be continuously renovated and the life time of the digital consumer products is relatively short. Moreover, with the increasing of the variety of digital consumer products' functionality, the demand for larger storage space for storing digital pictures and digital video files is high.

Therefore, as a new digital product is developed, it is better to create a file system for the digital product utilizing relatively small storage space. Preferably, storage space occupied by the file system in the digital product should be as small as possible. That is, the file system is exclusively built according to the functionality of the digital products and provides only the necessary files for maintaining the normal operations of the digital product. Moreover, when the development environment for the new digital product is built, the research team usually re-establishes a file system. Nevertheless, re-establishing a file system consumes a lot of time and labor. Besides, the research team needs to solve the integration problems during the establishment of the file system. Furthermore, since the life time of the digital consumer products is short, re-establishing a file system cannot keep pace with the variation of the market.

### SUMMARY OF THE INVENTION

Accordingly, at least one objective of the present invention is to provide a file system builder. By using the file system builder, a customized file system for a target machine can be built from a source package system of a source machine. Hence, the time used to build up a development environment can be saved.

At least another objective of the present invention is to provide a method for building up a file system. According to the required functionality, a small and exclusive file system can be rapidly built from a source development environment.

To achieve these and other advantages and in accordance with the purpose of the invention, as embodied and broadly described herein, the invention provides a file system builder for building a file system from a source package database of a source machine with a first platform according to a keyword, wherein the file system can be installed into a target machine with a second platform. The system builder comprises a file system, a generator and a fine tuner. The file system builder engine is used for performing a first query-response communication with the source machine according to the keyword to obtain a package list from the source package database and building up a package table according to the package list, wherein the package list comprises at least one package name. The generator is used for generating a target package set according to the package table and the second platform, wherein the target package set comprises at least one package. The fine tuner is used for adjusting the target package set to be a file system.

According to the file system builder described in the embodiment of the present invention, for each package name in the package table, a dependency package list and a supply-able file list are correspondingly stored.

According to the file system builder described in the embodiment of the present invention, the file system builder engine performs a second query-response communication with the source package database according to each package name in the package table to obtain the corresponding dependency package list and the supply-able file list.

According to the file system builder described in the embodiment of the present invention, the file system builder further comprises an input interface module for receiving the input keyword and transferring the input keyword to the file system builder engine.

According to the file system builder described in the embodiment of the present invention, the file system builder further comprises a history record for correspondingly recording a plurality of history fine tuning rules of each package.

According to the file system builder described in the embodiment of the present invention, the fine tuner performs a third query-response communication with source machine to adjust the target package set to be the file system.

According to the file system builder described in the embodiment of the present invention, the first platform is different from the second platform.

According to the file system builder described in the embodiment of the present invention, the first platform is as same as the second platform.

According to the file system builder described in the embodiment of the present invention, each of the packages complies with a file standard of RedHat Package Management (RPM).

According to the file system builder described in the embodiment of the present invention, the source package database includes an RPM database.

The present invention also provides a method for building up a file system from a source package database of a source machine with a first platform according to a keyword, wherein the file system can be installed into a target machine with a second platform. The method comprises steps of performing a first query-response communication, according to the keyword, to obtain a package list from the source package database, wherein the package list comprises at least one package name. S package table is built up according to the package list. A target package set is generated according to the package table and the second platform, wherein the target package set comprises at least one package. The target package set is fine tuned to be a target file system.

According to the method described in the embodiment of the present invention, the method for building up the package table comprises steps of performing a second query-response communication with the source package database according to each package name in the package list to correspondingly obtain a dependency package list and a supply-able file list.

According to the method described in the embodiment of the present invention, the dependency package list has at least one dependency package name, the dependency package names which have not shown in the package list are added into the package list.

According to the method described in the embodiment of the present invention, the method for generating the target package set comprises a step of collecting the packages, which are compatible with the second platform, from the source package database to form the target package set according to the package list of the package table.

According to the f method described in the embodiment of the present invention, the method of fine tuning the target package set comprises a step of performing a third query-response communication with the source machine to fine tune the target package set to be the target file system according to a history record.

According to the method described in the embodiment of the present invention, in the third query-response communication, it further comprises a step of obtaining at least one file from a source file system of the source machine into the target package set.

According to the method described in the embodiment of the present invention, the file includes a system registration file and a user name file.

According to the method described in the embodiment of the present invention, the first platform is different from the second platform.

According to the method described in the embodiment of the present invention, the first platform is as same as the second platform.

According to the method described in the embodiment of the present invention, each of the packages complies with a file standard of RedHat Package Management (RPM).

According to the method described in the embodiment of the present invention, the source package database includes an RPM database.

In the present invention, the file system builder engine of the file system builder performs a query-response communication, according to the input keyword, with a source package database of a source machine to build up a package table with respect to the input keyword. The generator generates a target package set, which can be installed onto a target machine, from the package table. The fine tuner adjusts the target set to be a target file system compatible for the target machine. That is, the customized development environment is built up according to the keyword. Since the development environment is built up based on the keyword (the required functionality), the file system can provide the necessary functionality without occupying a lot of storage space. Moreover, by using the file system builder, the new development environment can be rapidly established from the source development environment so that the time for re-building a development environment can be saved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a file system builder according to a preferred embodiment of the invention.

FIG. 2 is a flow chart showing a method for building up a file system according to one embodiment of the present invention.

### DESCRIPTION OF THE PREFERRED EMBODIMENTS

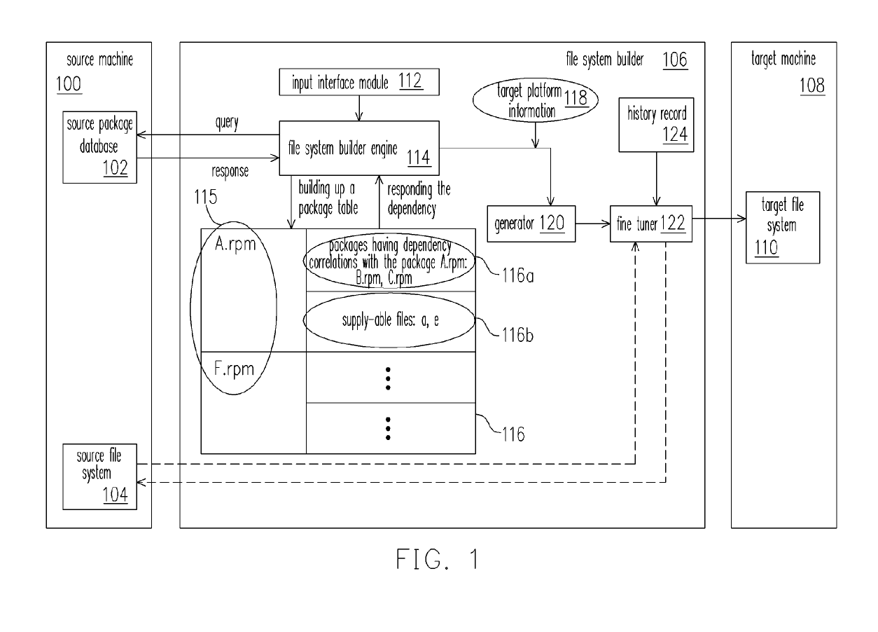

FIG. 1 is a schematic diagram illustrating a file system builder according to a preferred embodiment of the invention. As shown in FIG. 1, a source machine 100 with a first platform comprises a source package database 102 and a source file system 104. The source machine 100 can be, for example but not limited to, a personal computer. The first platform can be, for example but not limited to, an x86 platform or an Alpha platform. Furthermore, in the source machine 100, a RedHat Package Management (RPM) system is installed and running. In this circumstance, the source package database 102 is an RPM database.

Moreover, a file system builder 106 comprises an input interface module 112, a file system builder engine 114, a generator 120 and a fine tuner 122. Further, a target machine 108 is a machine with a second platform. The target machine 108 can be, for example but not limited to, a multimedia box or a digital functional product possessing a playback function for playing a DVD. The second platform can be, for example but not limited to, an x86 platform or an Alpha platform.

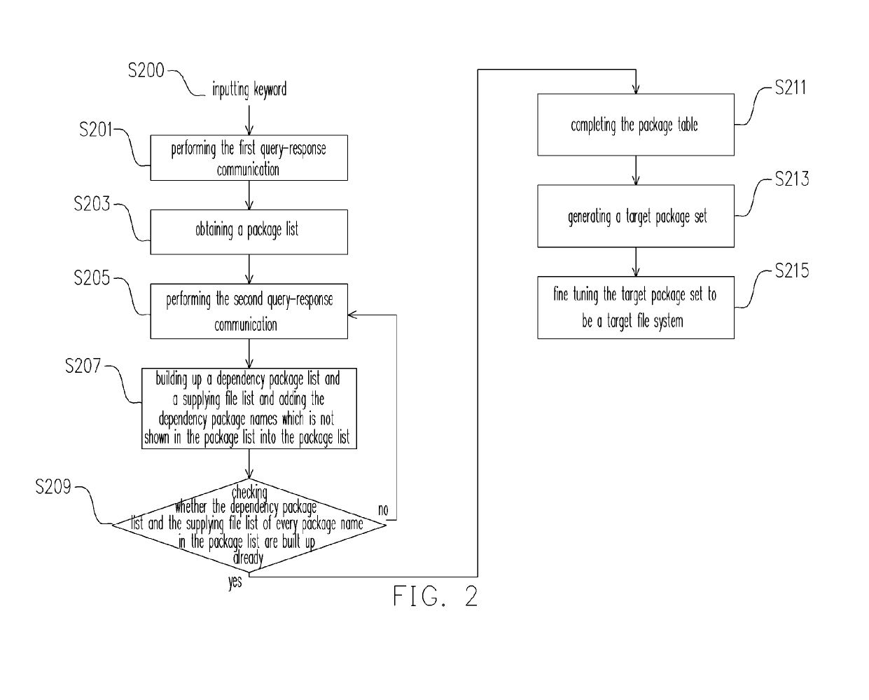

FIG. 2 is a flow chart showing a method for building up a file system according to one embodiment of the present invention. As shown in FIG. 1 and FIG. 2, in the step S200, the input interface module 112 receives a keyword and transfers the input keyword to the file system builder engine 114. The file system builder engine 114 performs a first query-response communication with the source machine 100 (step S201), according to the keyword, to obtain a package list 115 from the source package database 102 (step S203). According to the package list 115, the file system builder engine 114 builds up a package table 116. The package list 115 comprises at least one package name. Preferably, the package names in the package list 115 comply with the RPM naming standard. The package name can be, for example but not limited to, package name-version.architecture.rpm, wherein package name represents name of the package, version represents the version of the package and the architecture represents the platform type of the hardware.

Taking a multimedia box having the playback function for playing a DVD as an example, when the system (the multimedia box) is designed to have Gnome CD Player as the playback software, the keyword “gnome-cd” is input into the input interface module 112. Then, according to the keyword, the file system builder engine 114 queries the source package database 102 of the source machine 100 and receives a response including a package list with respect to the keyword, “gnome-cd”, from the source package database 102 (first query-response communication, step S201). That is, the package list comprises the names of all the packages necessary for executing a function about “gnome-cd”. As shown in FIG. 1, the package list 115 in the package table 116 comprises A.rpm and F.rpm.

The step that file system builder engine 114 builds up the package table according to the package list 115 further comprises a step of performing a second query-response communication (step S205). That is, the file system builder engine 114 queries the source package database 102 according to each package name in the package list 115 and receives a response including a dependency package list 116a and a supply-able file list 116b respectively corresponding to each package name in the package list 115 (step S207). Taking A.rpm in the package list 115 as an example, file system builder engine 114 performs a second query-response communication with the source package database 102 according to A.rpm to obtain the dependency package list 116a with respect to A.rpm and the supply-able file list 116b with respect to A.rpm. It should be noticed that the dependency package list 116a includes dependency package names such as B.rpm and C.rpm and the dependency packages listed in the dependency package list have dependency correlations with the package A.rpm. Furthermore, the supply-able file list 116b includes file names such as a and e and the files referred by file names in the file list 116b are that the package A.rpm can provide.

Once the second query-response communication is performed to obtain a dependency package list 116a and a supply-able file list 116b corresponding to a package in the package list 115, when the dependency package list 116a possesses at least one dependency package name, the dependency package names which have not shown in the package list 115 are added into the package list 115. That is, as shown in FIG. 1, for the package A.rpm, when the dependency package names, B.rpm and C.rpm, is not listed in the package list 115, the file system builder engine 114 adds the dependency package names, B.rpm and C.rpm, into the package list 115. On the other words, the package list 115 expands with each time of the second query-response communications. After the dependency package list 116a and the supply-able file list 116b for a package name in the package list 115 are built up, the file system builder engine 114 checks whether the dependency package list 116a and the supply-able file list 116b of every package name in the package list 115 are built up already (step S209) (that is, the second query-response communication should be performed once for each package name in the package list 115). If the checking result shows that the dependency package list and the supply-able file list are not built up for some package name in the package list, the file system builder engine 114 performs the second query-response communication with the source machine according to the posterior package name in the package list 115 to form the package table 116. That is, the file system builder engine 114 continuously performs the second query-response communication until all package names in the package list are queried to build up the corresponding dependency package lists 116a and the corresponding supply-able file lists 116b.

If the checking result shows that all the package names in the package list 115 have been queried, the package table 116 is completely formed (step S211). As shown in FIG. 1 and FIG. 2, the generator 120 generates a target package set (step S213) according to the package table 116 and the type the second platform 118 (second platform information). That is, in the step S213, generator 120, according to the package name listed in the package table 116 and the second platform information, collects (obtains) packages necessary for the function with respect to the key word and compatible with the second platform from the source package database 102 to be a target package set. The target package set comprises at least one package. Preferably, the packages in the target package set comply with a file standard of RPM.

Thereafter, the fine tuner 122 fine tune the target package set to be a target file system (step S215), wherein the target file system can be installed into the target machine 108 with the second platform to be a target file system 110. It should be noticed that the method for fine tuning the target package set comprises that the fine tuner 122 performs a third query-response communication with the source machine 100 according to a history record to adjust the target package set to be a target file system. Preferably, the fine tuner 122 queries the source machine 100 about the necessary files according to the history record 124 and receives the corresponding response to obtain the files. The aforementioned history record 124 is used to record the history tuning rules corresponding to each package. Moreover, the method for obtaining the history tuning rules comprises step of installing the target file system onto the target machine 108 and then performing a serial test runs to obtain the necessary fine tuning information. Finally, the fine tuning information is collected to be the history tuning rules. Further, the aforementioned files necessary for the fine tuning process (step S215) and collected from the source file system 104 can be, for example but not limited to, a system registration file or a user name file.

In the present invention, according to the input keyword, the file system builder engine of the file system builder obtains a package list from the source package database of the source machine. By referring to the package list, a package table with respect to the input keyword is built. Then, basing on the platform information of the target machine and the package table, the generator generates the target package set for the target machine from the source package database. Thereafter, the fine tuner adjusts the target package set to be a target file system compatible with the target machine. That is, a customized file system for the target machine according to the keyword is built.

Since the target file system is built according to the keyword, the target file system can provide the desired functions without occupying storage space. Furthermore, by using the file system builder, the customized file system can be rapidly built from the source package database so that the time for re-building up a new development environment can be saved. Therefore, the target file system can be built up in a short time to keep pace with the short life time of the digital consumer product. Since the target file system is built based on the source package database of the source machine, the problem of the system integration can be overcome. Furthermore, the target file system is built according to the platform of the target machine so that the target file system built from the source machine can compatible with the target machine.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A file system builder for building a file system from a source package database of a source machine with a first platform according to a keyword, wherein the file system can be installed into a target machine with a second platform, the system builder comprising:
a file system builder engine for performing a first query-response communication with the source machine according to the keyword to obtain a package list from the source package database and building up a package table according to the package list, wherein the package list comprises at least one package name;
a generator for generating a target package set according to the package table and the second platform, wherein the target package set comprises at least one package; and
a fine tuner for fine tuning the target package set to be a file system.

2. The file system builder of claim 1, wherein, for each package name in the package table, a dependency package list and a supply-able file list are correspondingly stored.

3. The file system builder of claim 2, wherein the file system builder engine performs a second query-response communication with the source package database according to each package's name in the package table to obtain the corresponding dependency package list and the supply-able file list.

4. The file system builder of claim 1 further comprising an input interface module for receiving the input keyword and transferring the input keyword to the file system builder engine.

5. The file system builder of claim 1 further comprising a history record for correspondingly recording a plurality of history fine tuning rules of each package.

6. The file system builder of claim 5, wherein the fine tuner, according to said history record and the source machine, performs a third query-response communication to fine tuning the target package set to be the file system.

7. The file system builder of claim 1, wherein the first platform is different from the second platform.

8. The file system builder of claim 1, wherein the first platform is as same as the second platform.

9. The file system builder of claim 1, wherein each of the packages complies with a file standard of RedHat Package Management (RPM).

10. The file system builder of claim 1, wherein the source package database includes an RPM database.

11. A method for building up a file system from a source package database of a source machine with a first platform according to a keyword, wherein the file system can be installed into a target machine with a second platform, the method comprising:
performing a first query-response communication, according to the keyword, to obtain a package list from the source package database, wherein the package list comprises at least one package name;
building up a package table according to the package list;
generating a target package set according to the package table and the second platform, wherein the target package set comprises at least one package; and
fine tuning the target package set to be a target file system.

12. The method of claim 11, wherein the method for building up the package table comprises steps of performing a second query-response communication with the source package database according to each package name in the package list to correspondingly obtain a dependency package list and a supply-able file list.

13. The method of claim 12, wherein, when the dependency package list has at least one dependency package name, the dependency package names which have not shown in the package list are added into the package list.

14. The method of claim 11, wherein the method for generating the target package set comprises a step of collecting the packages, which are compatible with the second platform, from the source package database to form the target package set according to the package list of the package table.

15. The method of claim 11, wherein the method of fine tuning the target package set comprises a step of performing a third query-response communication with the source machine to fine tune the target package set to be the target file system according to a history record.

16. The method of claim 15, wherein, in the third query-response communication, it further comprises a step of obtaining at least one file from a source file system of the source machine into the target package set.

17. The method of claim 16, wherein the file includes a system registration file and a user name file.

18. The method of claim 11, wherein the first platform is different from the second platform.

19. The method of claim 11, wherein the first platform is as same as the second platform.
